(19) United States
(12) Patent Application Publication
(10) Pub. No.: US 2025/0154809 A1
(43) Pub. Date: May 15, 2025

(54) HINGE ASSEMBLY OF SCISSOR DOOR AND VEHICLE HAVING SAME

(71) Applicants: ZHEJIANG GEELY HOLDING GROUP CO., LTD., Hangzhou (CN); GEELY AUTOMOBILE RESEARCH INSTITUTE (NINGBO) CO., LTD., Ningbo (CN)

(72) Inventors: Jinxing DING, Hangzhou (CN); Jinbo ZENG, Hangzhou (CN); Yunlong ZHANG, Hangzhou (CN); Hao ZHANG, Hangzhou (CN); Jian ZHOU, Hangzhou (CN); Hongbin RAN, Hangzhou (CN); Wei ZHANG, Hangzhou (CN)

(21) Appl. No.: 19/021,261

(22) Filed: Jan. 15, 2025

Related U.S. Application Data
(63) Continuation of application No. PCT/CN2022/110588, filed on Aug. 5, 2022.

(51) Int. Cl. E05D 3/10; E05F 15/60

(52) U.S. Cl. CPC E05D 3/10; E05F 15/60; E05Y 2201/624; E05Y 2900/531

(57) ABSTRACT

Provided are a hinge assembly of a scissor door and a vehicle. The hinge assembly includes a mounting base, a connection base, a first rotation member rotatably connected to the mounting base, a second rotation member rotatably connected to the mounting base, a first hinge arm connected between the first rotation member and the connection base, and a second hinge arm connected between the first rotation member and the connection base.

### CROSS-REFERENCE TO RELATED APPLICATION

This application is a continuation of International Application No. PCT/CN2022/110588, titled “HINGE ASSEMBLY OF SCISSOR DOOR AND VEHICLE HAVING SAME” and filed on Aug. 5, 2022, the entire contents of which are incorporated herein by reference.

### FIELD

The present disclosure relates to the field of vehicle technologies, and more particularly, to a hinge assembly of a scissor door and a vehicle having same.

### BACKGROUND

In today's automotive world, where novelty and technology are increasingly pursued, a method for opening a vehicle door is crucial to creation of a sense of technology, considering that the vehicle door is the first system passengers come into contact with when entering a vehicle cabin. A hinge assembly of a scissor door in the related art takes up a large space and is not applicable to small vehicles.

### SUMMARY

Embodiments of the present disclosure are to provide a hinge assembly of a scissor door. The hinge assembly includes a mounting base, a connection base, a first rotation member, a second rotation member, and a first hinge arm. The mounting base is provided with a first mounting portion and a second mounting portion spaced apart from each other. The connection base is provided with a first connection portion and a second connection portion spaced apart from each other. The first rotation member is rotatably connected to the first mounting portion and provided with a first hinge portion. The second rotation member is rotatably connected to the second mounting portion and provided with a second hinge portion. The second hinge portion is rotatably connected to the second connection portion. The first hinge arm has a first end and a second end. The first end is rotatably connected to the first hinge portion, and the second end is rotatably connected to the first connection portion.

Embodiments of the present disclosure are also to provide a vehicle. The vehicle includes a vehicle body, a vehicle door, and the hinge assembly of the scissor door as described in the above embodiments. The mounting base is fixed at the vehicle body. The connection base is fixed at the vehicle door.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

FIG. 1 is a schematic view of a hinge assembly of a scissor door according to an embodiment of the present disclosure, viewed from one perspective.

FIG. 2 is a schematic view of the hinge assembly of the scissor door illustrated in FIG. 1, viewed from another perspective.

FIG. 3 is a schematic view of the hinge assembly of the scissor door illustrated in FIG. 2, in which a connection base is at an open position relative to a mounting base.

FIG. 4 is a schematic view of the hinge assembly of the scissor door illustrated in FIG. 1, viewed from yet another perspective.

FIG. 5 is a partial enlarged view of the hinge assembly in FIG. 4.

FIG. 6 is a schematic view of a mounting base illustrated in FIG. 1.

FIG. 7 is a schematic view of a connection base illustrated in FIG. 1.

FIG. 8 is a schematic view of a first rotation member illustrated in FIG. 1.

FIG. 9 is a schematic view of a second rotation member illustrated in FIG. 1.

FIG. 10 is a schematic view of a first hinge arm illustrated in FIG. 1.

FIG. 11 is a schematic view of a second hinge arm illustrated in FIG. 1.

FIG. 12 is a schematic partial view of a vehicle according to an embodiment of the present disclosure, in which a vehicle door is in a closed state.

FIG. 13 is a schematic view of the vehicle illustrated in FIG. 12, in which a vehicle door is in an open state.

FIG. 14 is another schematic view of the vehicle in FIG. 13.

Reference numerals of the accompanying drawings:
100, hinge assembly;
10, mounting base; 11, first mounting portion; 111, fixing plate; 12, second mounting portion; 13, vehicle body connection hole; 14, first support portion;
20, connection base; 21, first connection plate; 211, vehicle door connection hole; 22, second connection plate; 221, first plate segment; 2211, first connection portion; 222, bent segment; 223, second plate segment; 2231, second connection portion; 23, second support portion;
30, first rotation member; 31, first connection shaft; 32, first hinge portion;
40, second rotation member; 41, first segment; 411, first connection hole; 42, second segment; 421, second hinge portion;
50, first hinge arm; 51, first end; 511, first hinge hole; 52, second end; 521, second hinge hole; 53, connection segment;
60, second hinge arm; 61, third end; 611, fourth connection shaft; 62, fourth end; 621, third hinge hole;
70, support rod; 81, fifth connection shaft; 82, sixth connection shaft;
L1, first axis; L2, second axis; L3, third axis; L4, fourth axis; L5, fifth axis; L6, sixth axis; A1, first intersection; A2, second intersection; A3, third intersection;
1000, vehicle; 200, vehicle body; 300, vehicle door.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limit, the present disclosure.

Embodiments of the present disclosure provide a hinge assembly of a scissor door. With the hinge assembly of the scissor door, combined side-upward opening of a vehicle door can be realized. Such an opening method is not only novel but also provides a sense of technology. Further, a volume of the hinge assembly can be reduced while realizing a same opening angle and a same opening height, which reduces space occupation. Further, the hinge assembly is applicable to a wide range of small vehicles, enhancing applicability of the hinge assembly.

Embodiments of the present disclosure further provide a vehicle including the hinge assembly described above.

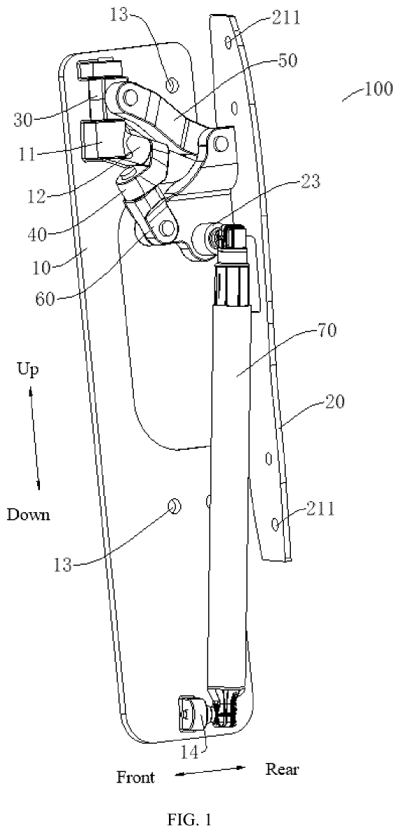

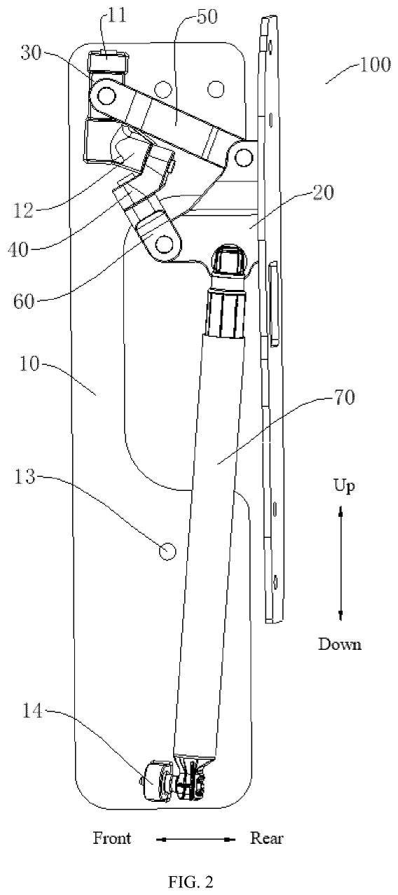

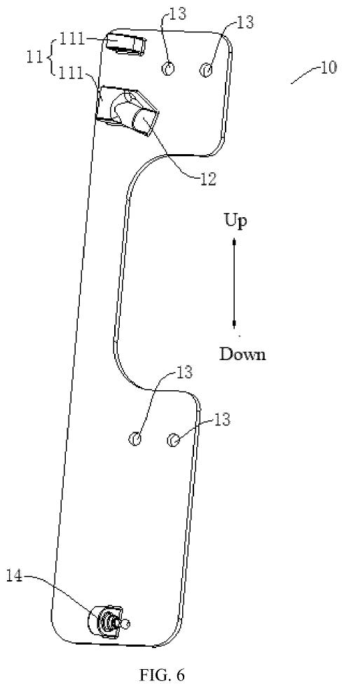

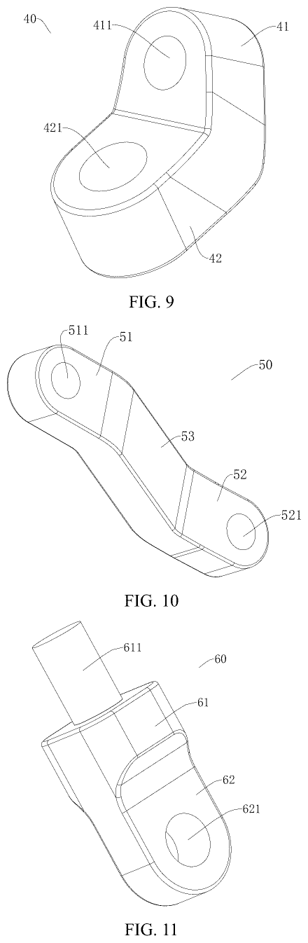

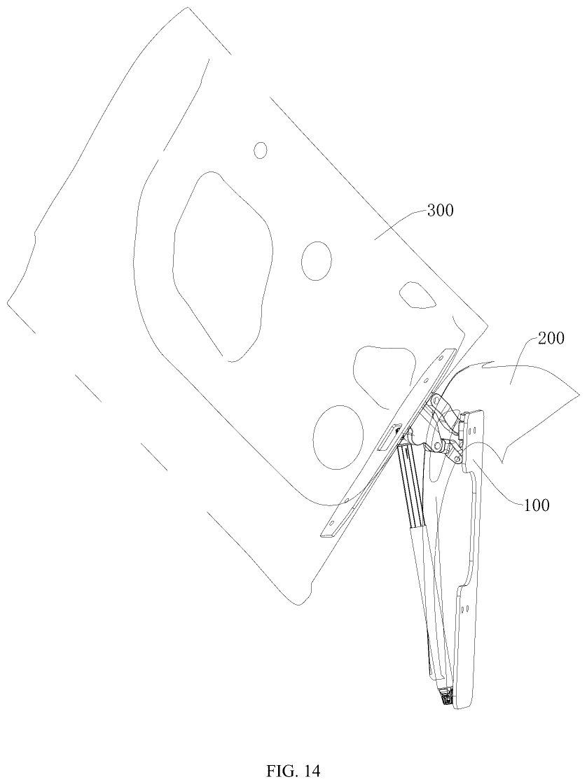

A hinge assembly 100 of a scissor door according to embodiments of the present disclosure is described below with reference to FIG. 1 to FIG. 14.

As illustrated in FIG. 1, the hinge assembly 100 of the scissor door according to the embodiments of the present disclosure includes a mounting base 10, a connection base 20, a first rotation member 30, a second rotation member 40, a first hinge arm 50, and a second hinge arm 60.

In an exemplary embodiment of the present disclosure, the mounting base 10 is connected to a vehicle body 200 of a vehicle 1000. The mounting base 10 is provided with a first mounting portion 11 and a second mounting portion 12. The first mounting portion 11 is spaced apart from the second mounting portion 12. For example, as illustrated in FIG. 1, the mounting base 10 extends vertically, the first mounting portion 11 and the second mounting portion 12 are arranged at the mounting base 10 in a manner of being spaced apart from each other in an up-down direction. In addition, the second mounting portion 12 is located below the first mounting portion 11.

As illustrated in FIG. 1, the connection base 20 is connected to a vehicle door 300. The connection base 20 is provided with a first connection portion 2211 and a second connection portion 2231. The first connection portion 2211 and the second connection portion 2231 are spaced apart from each other. For example, as illustrated in FIG. 1, the connection base 20 is arranged vertically. The first connection portion 2211 and the second connection portion 2231 are arranged at the connection base 20 in a manner of being spaced apart from each other in the up-down direction. In addition, the second connection portion 2231 is located below the first connection portion 2211.

As illustrated in FIG. 1, the first rotation member 30 is rotatably connected to the first mounting portion 11. The first rotation member 30 is provided with a first hinge portion 32. For example, the first rotation member 30 is disposed at the first mounting portion 11, and the first rotation member 30 is rotatable about a vertical axis relative to the first mounting portion 11 in a left-right direction.

As illustrated in FIG. 1, the second rotation member 40 is rotatably connected to the second mounting portion 12. The second rotation member 40 is provided with a second hinge portion 421. For example, the second rotation member 40 is disposed at the second mounting portion 12, and is rotatable in the up-down direction about an axis extending in a front-rear direction. When the second rotation member 40 is rotated from bottom to top, not only can the vehicle door 300 be opened upwards, but also the vehicle door 300 can be opened outwards.

The first hinge arm 50 has a first end 51 and a second end 52. The first end 51 is rotatably connected to the first hinge portion 32. The second end 52 is rotatably connected to the first connection portion 2211. That is, the first hinge arm 50 is connected between the first hinge portion 32 of the first rotation member 30 and the first connection portion 2211 of the connection base 20.

Further, the second hinge portion 421 of the second rotation member 40 is rotatably connected to the second connection portion 2231 of the connection base 20. For example, the second hinge portion 421 and the second connection portion 2231 may be rotatably connected to each other by a structure such as a ball stud or a rod end bearing.

Since the first mounting portion 11 and the second mounting portion 12 are sequentially arranged, the first rotation member 30 and the second rotation member 40 are sequentially arranged at the mounting base 10. When the second rotation member 40 is pivoted upwards about the axis extending in the front-rear direction, the first rotation member 30 is rotated in the left-right direction about an axis extending vertically, and synchronously drives the first end 51 of the first hinge arm 50 to move outwards. In this way, by rotating, the first rotation member 30 and the first hinge arm 50 can clear a predetermined space to facilitate upward pivoting of the second rotation member 40, preventing the second rotation member 40 and the first hinge arm 50 from interfering with each other.

When the vehicle door 300 is connected to the vehicle body 200 by the hinge assembly 100 of the scissor door according to the embodiment, a force applied to the vehicle door 300 to open the vehicle door 300 is transmitted to the connection base 20 through the vehicle door 300. The connection base 20 can transmit the force to the first rotation member 30 and the second rotation member 40 through the first hinge arm 50 and the second hinge arm 60, respectively, in such a manner that the first rotation member 30 rotates about the first mounting portion 11 and the second rotation member 40 rotates about the second mounting portion 12. Therefore, the vehicle door 300 is opened upwards in the left-right direction. That is, when opening the vehicle door 300, the vehicle door 300 is opened upwards while being opened outwards in the left-right direction, which realizes combined side-upward opening. Such an opening method is not only novel but also provides a sense of technology. By rotating the first rotation member 30 to drive the first hinge arm 50 to rotate about the first mounting portion 11, such an arrangement can prevent the first hinge arm 50 from appearing in a rotational region of the second rotation member 40, ensuring smooth opening of the vehicle door 300.

It should be noted that, the hinge assembly 100, the mounting base 10, the connection base 20, the first rotation member 30, the second rotation member 40, and the first hinge arm 50 according to this embodiment together form a four-link mechanism. The first rotation member 30 and the first hinge arm 50 form a first movable arm of the four-link mechanism. The second rotation member 40 forms a second movable arm of the four-link mechanism. In a process of opening the vehicle door 300, the first movable arm can realize a combined upward-outward movement through an engagement between the first rotation member 30 and the first hinge arm 50, and the second movable arm can realize a combined upward-outward movement through a rotation of the second rotation member 40. As a result, a volume of the hinge assembly 100 can be reduced while realizing a same opening angle and a same opening height, which reduces space occupation and makes a door opening process more labor-saving. Further, the hinge assembly 100 is applicable to a wide range of small vehicles, enhancing applicability of the hinge assembly 100.

With the hinge assembly 100 of the scissor door according to the embodiment of the present disclosure, the vehicle door 300 can be opened upwards while being opened outwards in the left-right direction, which realizes the combined side-upward opening of the vehicle door 300. Such an opening method is not only novel but also provides the sense of technology. Further, the volume of the hinge assembly 100 can be reduced while realizing the same opening angle and the same opening height, which reduces the space occupation and makes the door opening process more labor-saving. Further, the hinge assembly 100 is applicable to a wide range of small vehicles, enhancing the applicability of the hinge assembly 100.

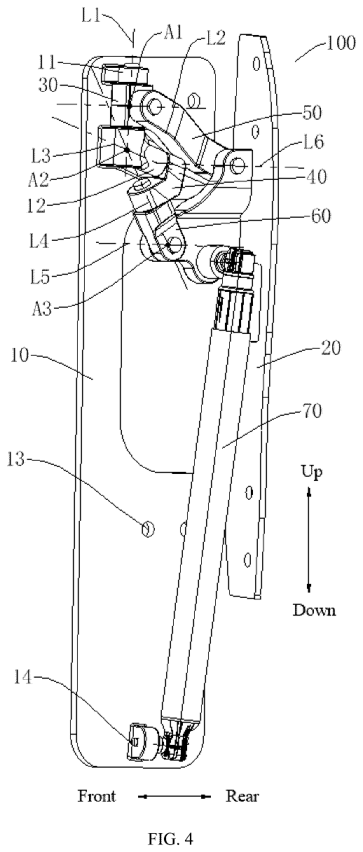

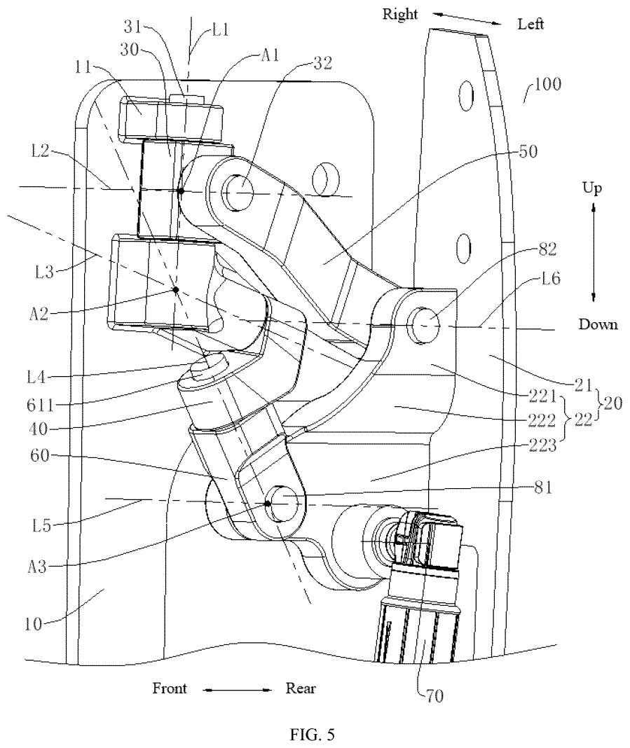

In some embodiments of the present disclosure, as illustrated in FIG. 4 and FIG. 5, the first rotation member 30 is rotatable relative to the first mounting portion 11 about a first axis L1, and the first hinge arm 50 is rotatable relative to the first rotation member 30 about a second axis L2. The first axis L1 intersects with the second axis L2 at a first intersection A1. In an embodiment of the present disclosure, the first intersection A1 is located at the first rotation member 30. In this way, the vehicle door 300 can slide out smoothly.

In an embodiment of the present disclosure, as illustrated in FIG. 5, the hinge assembly 100 of the scissor door may further include a second hinge arm 60. The second hinge arm 60 has a third end 61 and a fourth end 62. The third end 61 is rotatably connected to the second hinge portion 421. The fourth end 62 is rotatably connected to the second connection portion 2231. That is, the second hinge arm 60 is connected between the second hinge portion 421 of the second rotation member 40 and the second connection portion 2231 of the connection base 20. In this case, the second rotation member 40 and the second hinge arm 60 form the second movable arm of the four-link mechanism. In the process of opening the vehicle door 300, the second movable arm can realize a combined dual-upward (which means that the second rotation member 40 is pivoted upwards and the second hinge arm 60 moves upwards) and outward movement through an engagement between the second rotation member 40 and the second hinge arm 60. As a result, an efficiency of door opening can be further improved. In addition, the volume of the hinge assembly 100 can be further reduced while realizing the same opening angle and the same opening height, which reduces the space occupation and makes the door opening process more labor-saving.

In an exemplary embodiment of the present disclosure, as illustrated in FIG. 5, the second rotation member 40 is rotatable about a third axis L3 relative to the second mounting portion 12, and the second hinge arm 60 is rotatable about a fourth axis L4 relative to the second rotation member 40. The first axis L1, the third axis L3, and the fourth axis L4 intersect at a second intersection A2. Therefore, any jamming during opening or closing of the vehicle door 300 can be avoided to enable the vehicle door 300 to slide out smoothly.

Further, as illustrated in FIG. 5, the first intersection A1 is non-coincident with the second intersection A2. When the first intersection A1 is coincident with the second intersection A2, the vehicle door 300 follows a curved trajectory along a spherical surface in the process of opening the vehicle door 300, which results in a long movement distance and requires great thrust and a long lever arm. When the first intersection A1 is non-coincident with the second intersection A2, the vehicle door 300 follows a curved trajectory along a rugby-ball-shaped surface in the process of opening the vehicle door 300. Under a condition of realizing the same opening angle and the same opening height, the movement distance of the vehicle door 300 can be reduced by ensuring that the first intersection A1 is non-coincident with the second intersection A2, which improves the efficiency of door opening and makes the door opening process more labor-saving.

In some embodiments of the present disclosure, as illustrated in FIG. 5, the second hinge arm 60 is rotatable about the fourth axis L4 relative to the second rotation member 40, and the second hinge arm 60 is rotatable about a fifth axis L5 relative to the second connection portion 2231. The fourth axis L4 intersects with the fifth axis L5 at a third intersection A3. In an embodiment of the present disclosure, the third intersection A3 is located at the second hinge arm 60. In this way, the vehicle door 300 can slide out smoothly.

Further, as illustrated in FIG. 5, the first intersection A1, the second intersection A2, and the third intersection A3 are non-coincident among each other. As a result, the efficiency of door opening can be improved while ensuring that the vehicle door 300 is opened or closed smoothly without any jamming, making an operation of opening or closing the vehicle door 300 more labor-saving.

In some embodiments of the present disclosure, as illustrated in FIG. 5, the first hinge arm 50 is rotatable about the second axis L2 relative to the first rotation member 30. The second hinge arm 60 is rotatable about the fifth axis L5 relative to the second connection portion 2231. The first hinge arm 50 is rotatable about a sixth axis L6 relative to the first connection portion 2211. The second axis L2, the fifth axis L5, and the sixth axis L6 are parallel to each other. Therefore, any jamming during the opening or the closing of the vehicle door 300 can be avoided to enable the vehicle door 300 to slide out smoothly.

In some embodiments of the present disclosure, as illustrated in FIG. 4, the mounting base 10 is arranged vertically. For example, the mounting base 10 is a plate that is arranged vertically and extends in the front-rear direction. The first mounting portion 11 and the second mounting portion 12 are disposed at an upper part of the mounting base 10. The second mounting portion 12 is located below the first mounting portion 11 and faces towards the connection base 20. For example, the first mounting portion 11 is located at an upper side of the second mounting portion 12, and the second mounting portion 12 is connected to a lower end of the first mounting portion 11 and located at a rear side of a lower part of the first mounting portion 11.

Further, the first rotation member 30 is rotatably disposed at the first mounting portion 11 about the first axis L1, and the second rotation member 40 is rotatably disposed at the second mounting portion 12 about the third axis L3. The first axis L1 extends vertically. The third axis L3 extends obliquely downwards from front to rear. As a result, the door opening is made more labor-saving. In addition, the volume of the hinge assembly 100 can be further reduced while realizing the same opening angle and the same opening height, which reduces the space occupation.

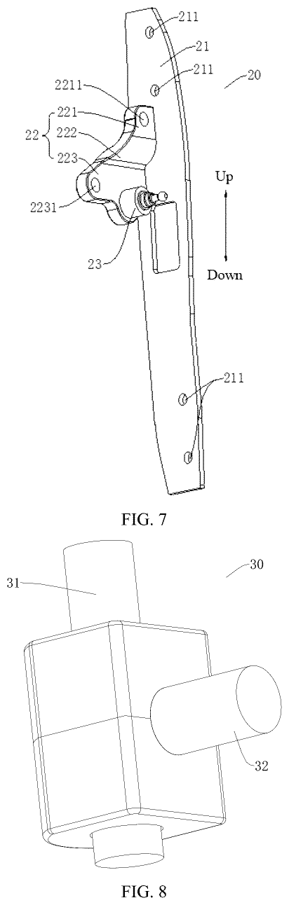

In some embodiments of the present disclosure, as illustrated in FIG. 5 and FIG. 7, the connection base 20 may include a first connection plate 21 and a second connection plate 22. The first connection plate 21 extends in the left-right direction and is connected to the vehicle door 300. The second connection plate 22 is connected to a front side surface of the first connection plate 21 and extends forwards. The first connection portion 2211 and the second connection portion 2231 are both disposed at the second connection plate 21. As a result, the connection base 20 can have a compact structure, which reduces the volume of the hinge assembly 100, reducing the space occupation.

In some examples, as illustrated in FIG. 7, the first connection plate 21 extends in the left-right direction and has a vehicle door connection hole 211. The vehicle door connection hole 211 penetrates the first connection plate 21 in the front-rear direction. A plurality of vehicle door connection holes 211 are formed and arranged at intervals at the first connection plate 21. A fastener, such as s screw, is configured to pass through the vehicle door connection hole 211 to fix the connection base 20 at the vehicle door 300.

In an exemplary embodiment of the present disclosure, as illustrated in FIG. 5 and FIG. 7, the second connection plate 22 is arranged vertically and extends in the front-rear direction. The second connection plate 22 includes a first plate segment 221, a bent segment 222, and a second plate segment 223 that are sequentially connected from top to bottom. The first plate segment 221 and the second plate segment 223 are offset from each other in the left-right direction. The first plate segment 221 is connected to the second plate segment 223 by the bent segment 222. For example, the bent segment 222 has an upper end connected to a lower end of the first plate segment 221, and a lower end extending obliquely downwards towards the second plate segment 223 and connected to an upper end of the second plate segment 223.

Further, as illustrated in FIG. 5, the second end 52 of the first hinge arm 50 is connected to the first plate segment 221 of the second connection plate 22 and located at a side of the first plate segment 221 in the left-right direction facing towards the bent segment 222 (e.g., a right side of the first plate segment 221 illustrated in FIG. 5). The fourth end 62 of the second hinge arm is connected to the second plate segment 223 of the second connection plate 22 and located at a side of the second plate segment 223 in the left-right direction facing towards the bent segment (e.g., a left side of the second plate segment 223 illustrated in FIG. 5). As a result, the hinge assembly 100 can have a more compact structure, which reduces the volume of the hinge assembly 100, reducing the space occupation of the hinge assembly 100.

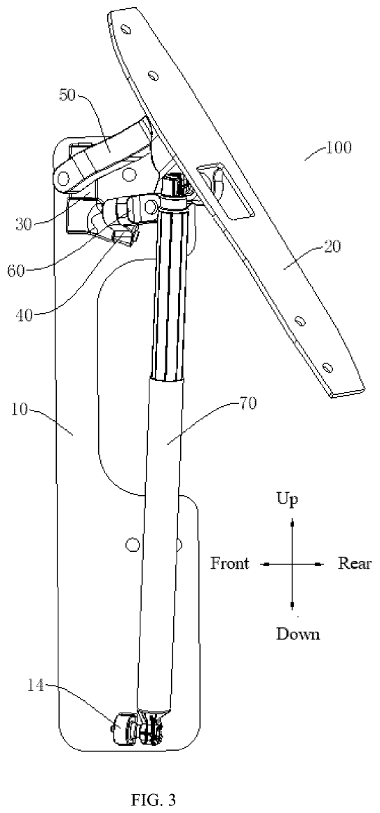

In some embodiments of the present disclosure, as illustrated in FIG. 3 to FIG. 5, the first hinge arm 50 is rotatably connected to the first rotation member 30 about the second axis L2. The first end 51 and the second end 52 of the first hinge arm 50 are offset from each other in a direction parallel to the second axis L2. The first hinge arm 50 further includes a connection segment 53. The connection segment 53 has an end (e.g., a front end of the connection segment 53 illustrated in FIG. 5) connected to the first end 51 and another end (e.g., a rear end of the connection segment 53 illustrated in FIG. 5) extending obliquely towards the second end 52. As a result, the hinge assembly 100 can have a more compact structure while facilitating connecting the first end 51 and the second end 52 of the first hinge arm 50 to the first rotation member 30 and the connection base 20, respectively, which reduces the space occupation of the hinge assembly 100.

In some embodiments of the present disclosure, as illustrated in FIG. 3 to FIG. 5, the second rotation member 40 is rotatable, about the third axis L3, between a first position (e.g., a position in which the second rotation member 40 is located as illustrated in FIG. 5) and a second position (e.g., a position in which the second rotation member 40 is located as illustrated in FIG. 3) relative to the second mounting portion 12. Further, the third axis L3 extends in the front-rear direction. When the second rotation member 40 is at the first position, the second hinge portion 421 is located below the third axis L3. When the second rotation member 40 is at the second position, the second hinge portion 421 is located above the third axis L3. As a result, when the second rotation member 40 is rotated from the first position to the second position, upward sliding of the vehicle door 300 can be realized. When the second rotation member 40 is at the first position, the vehicle door 300 is in a closed state. When the second rotation member 40 is at the second position, the vehicle door 300 is in a fully open state.

In an exemplary embodiment of the present disclosure, the second rotation member 40 includes a first segment 41 and a second segment 42 that are sequentially connected. Each of the first segment 41 and the second segment 42 extends along a straight line. The first segment 41 is obliquely arranged relative to the second segment 42. An obtuse angle is formed between the first segment 41 and the second segment 42. The first segment 41 is connected to the second mounting portion 12. The second hinge portion 421 is formed at the second segment 42. As a result, a structure of the second rotation member 40 can be simplified, making it easier for the vehicle door 300 to slide out smoothly.

Further, as illustrated in FIG. 5, in a direction from front to rear, the third axis L3 extends obliquely downwards from front to rear. In this way, when the second rotation member 40 is rotated from bottom to top, the second rotation member 40 can not only push the vehicle door 300 upwards to open the vehicle door 300, but also push the vehicle door 300 outwards in the left-right direction, which realizes the combined upward-outward movement of the vehicle door 300, further improving the efficiency of door opening.

In an embodiment of the present disclosure, the second mounting portion 12 is located at a side of the second rotation member 40 corresponding to an interior angle of the second rotation member 40. In this way, a height at which the vehicle door 300 is raised can be increased, which improves an opening efficiency of the vehicle door 300. That is, a size of the hinge assembly 100 can be reduced while realizing the same opening angle and the same opening height, which reduces the volume of the hinge assembly 100.

In some embodiments of the present disclosure, as illustrated in FIG. 3 and FIG. 4, the hinge assembly 100 of the scissor door further includes a support rod 70. The support rod 70 may be an electric support rod 70. The support rod 70 has two ends hinged to the mounting base 10 and the connection base 20, respectively, and is configured to drive the connection base 20 to move relative to the mounting base 10. In an exemplary embodiment of the present disclosure, the support rod 70 is arranged vertically. The support rod 70 has a lower end hinged to a lower end of the mounting base 10 and an upper end hinged to the second connection plate 22 of the connection base 20. When performing upward pushing, the support rod 70 may push the connection base 20 to move. Since the connection base 20 is connected to the mounting base 10 by the first rotation member 30, the second rotation member 40, the first hinge arm 50, and the second hinge arm 60, the connection base 20 realizes upward and outward pivoting under a force from the support rod 70. In this embodiment, with the support rod 70, the vehicle door 300 can be automatically opened or closed.

In an exemplary embodiment of the present disclosure, the mounting base 10 is in a shape of a plate arranged vertically. The first mounting portion 11 and the second mounting portion 12 are disposed at the upper part of the mounting base 10. The mounting base 10 is provided with a first support portion 14 at a lower part of the mounting base 10. The lower end of the support rod 70 is connected to the first support portion 14. The second connection plate 22 of the connection base 20 is provided with a second support portion 23. The second support portion 23 is located below the first connection portion 2211 and the second connection portion 2231. In addition, the second support portion 23 is located at a part of the second connection plate 22 close to the first connection plate 21. The upper end of the support rod 70 is connected to the second support portion 23. In an embodiment of the present disclosure, both the first support portion 14 and the second support portion 23 are formed as ball joint portions.

In some embodiments of the present disclosure, the mounting base 10, the connection base 20, the first rotation member 30, the second rotation member 40, the first hinge arm 50, and the second hinge arm 60 are connected to each other in a rotatable connection manner. The rotatable connection can be realized through an engagement between a rotary shaft and a shaft hole, a ball joint, or the rod end bearing.

A connection structure of the hinge assembly 100 of the scissor door according to this embodiment is described below only in terms of the rotatable connection realized through the engagement between the rotary shaft and the shaft hole. After reading the following embodiments, those skilled in the art can appreciate and obtain the connection structure of the hinge assembly 100 using the ball joint or the rod end bearing.

In an exemplary example, the first mounting portion 11 of the mounting base 10 includes two fixing plates 111 spaced apart from each other in the up-down direction. The fixing plate 111 has the shaft hole penetrating the fixing plate 111 in the up-down direction. The first rotation member 30 includes a first post and a first connection shaft 31. The first post is in a shape extending in the up-down direction and has a through hole penetrating the first post in the up-down direction. The first connection shaft 31 is rotatably disposed in the through hole of the first post, and has two ends engaged in the shaft holes of the two fixing plates 111. Therefore, the first rotation member 30 is rotatably connected to the mounting base 10. It should be noted that, positions of the first connection shaft 31 of the first rotation member 30 and the shaft hole of the first mounting portion 11 can be interchanged, as long as the first rotation member 30 can be rotatably connected to the first mounting portion 11.

In an exemplary example, the first hinge portion 32 of the first rotation member 30 is formed as a second connection shaft. The second connection shaft is connected to the first post and extends perpendicularly to an outer surface of the first post. The second connection shaft 32 is perpendicular to the first connection shaft 31. The first end 51 of the first hinge arm 50 has a first hinge hole 511. The second connection shaft 32 is rotatably engaged in the first hinge hole 511. In this way, the first rotation member 30 is rotatably connected to the first hinge arm 50. Positions of the second connection shaft of the first rotation member 30 and the first hinge hole 511 of the first hinge arm 50 can be interchanged, as long as the first rotation member 30 can be rotatably connected to the first hinge arm 50.

In an exemplary example, the second mounting portion 12 of the mounting base 10 is disposed below the first mounting portion 11, and is connected to a lower one of the two fixing plates 111. The second mounting portion 12 extends rearwards and downwards towards the connection base 20. The second mounting portion 12 is provided with a third connection shaft (not illustrated in the figures) at a rear end of the second mounting portion 12. The first segment 41 of the second rotation member 40 has a first connection hole 411 penetrating the first segment 41. The third connection shaft is engaged in the first connection hole 411. In this way, the mounting base 10 is rotatably connected to the second rotation member 40. Positions of the third connection shaft of the second mounting portion 12 and the first connection hole 411 of the second rotation member 40 can be interchanged, as long as the mounting base 10 can be rotatably connected to the second rotation member 40.

In an exemplary example, the second hinge portion 421 of the second rotation member 40 is formed as a second connection hole penetrating the second segment 42. A fourth connection shaft 611 is formed at the third end 61 of the second hinge arm 60 and is engaged in the second connection hole. In this way, the second hinge arm 60 is rotatably connected to the second rotation member 40. Positions of the second connection hole 421 of the second rotation member 40 and the fourth connection shaft 611 of the second hinge arm 60 can be interchanged, as long as the second hinge arm 60 can be rotatably connected to the second rotation member 40.

In an exemplary example, the fourth end 62 of the second hinge arm 60 has a third hinge hole 621. The second connection portion 2231 of the connection base 20 is formed as a second perforation hole penetrating the second plate segment 223. A fifth connection shaft 81 has an end fixed in the second perforation hole and another end rotatably engaged in the third hinge hole 621. In this way, the second hinge arm 60 is rotatably connected to the connection base 20. Positions of the fifth connection shaft 81 disposed at the connection base 20 and the third hinge hole 621 of the second hinge arm 60 can be interchanged, as long as the second hinge arm 60 can be rotatably connected to the connection base 20.

In an exemplary example, the first connection portion 2211 of the connection base 20 is formed as a first perforation hole penetrating the first plate segment 221, and the second end 52 of the first hinge arm 50 has a second hinge hole 521. A sixth connection shaft 82 has an end fixed in the first perforation hole 2211 and another end rotatably engaged in the second hinge hole 521. In this way, the first hinge arm 50 is rotatably connected to the connection base 20. Positions of the sixth connection shaft 82 disposed at the connection base 20 and the second hinge hole 521 of the first hinge arm 50 can be interchanged, as long as the first hinge arm 50 can be rotatably connected to the connection base 20.

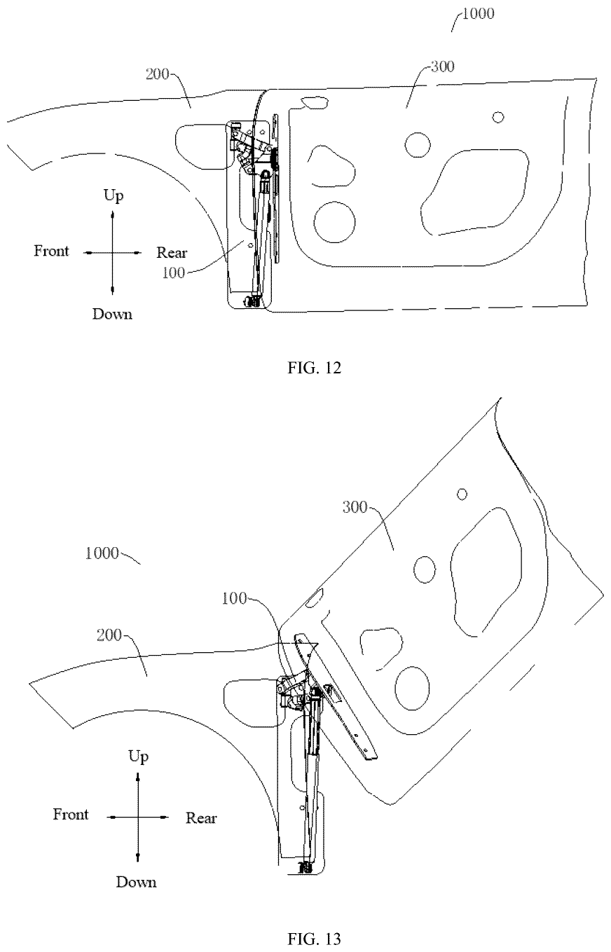

As illustrated in FIG. 12 to FIG. 14, a vehicle 1000 according to embodiments of the present disclosure includes a vehicle body 200, a vehicle door 300, and the hinge assembly 100 of the scissor door according to any of the above embodiments. The mounting base 10 is fixed at the vehicle body 200. The connection base 20 is fixed at the vehicle door 300.

Other components and operations of the vehicle 1000 according to the embodiments of the present disclosure are known to those of ordinary skill in the art, and thus details thereof will be omitted here.

For the vehicle 1000 according to the embodiments of the present disclosure, the hinge assembly 100 of the scissor door according to any of the embodiments in the first aspect described above is provided, which improves overall performance of the vehicle 1000.

A vehicle 1000 according to an exemplary embodiment of the present disclosure will be described below with reference to FIG. 1 to FIG. 14.

As illustrated in FIG. 12 to FIG. 14, the vehicle 1000 includes a vehicle body 200, a vehicle door 300, and a hinge assembly 100 connected between the vehicle body 200 and the vehicle door 300.

In an exemplary embodiment of the present disclosure, as illustrated in FIG. 1, the hinge assembly 100 includes a mounting base 10, a connection base 20, a first rotation member 30, a second rotation member 40, a first hinge arm 50, a second hinge arm 60, and a support rod 70. The mounting base 10 is fixed at the vehicle body 200. The connection base 20 is fixed at the vehicle door 300.

As illustrated in FIG. 5, the first rotation member 30 is rotatably connected to the mounting base 10 through a first axis L1 arranged vertically. That is, the first rotation member 30 is rotatable about the first axis L1. The first hinge arm 50 has an end rotatably connected to the first rotation member 30 about the second axis L2 which is perpendicular to the first axis L1. The first axis L1 intersects with the second axis L2 at the first intersection A1. The first hinge arm has another end rotatably connected to the connection base 20 about the sixth axis L6. The second rotation member 40 has an end rotatably connected to the mounting base 10 about the third axis L3, and another end rotatably connected to an end of the second hinge arm 60 about the fourth axis L4. The first axis L1, the third axis L3, and the fourth axis L4 intersect with each other at the second intersection A2. The second hinge arm 60 has another end rotatably connected to the connection base 20 about the fifth axis L5. The fourth axis L4 intersects with the fifth axis L5 at the third intersection A3. The first intersection A1, the second intersection A2, and the third intersection A3 is non-coincident with each other. The second axis L2, the fifth axis L5, and the sixth axis L6 are parallel to each other.

As illustrated in FIG. 5, the mounting base 10 has a vehicle body connection hole 13 and is fixed at the vehicle body 200 through the vehicle body connection hole 13. The mounting base 10 is formed into a shape of a plate that is arranged vertically and extends in the front-rear direction. The mounting base 10 includes the two fixing plates 111. The first rotation member 30 has a shaft hole penetrating the first rotation member 30 vertically. The fixing plate 111 is connected to the first rotation member 30 by the first connection shaft 31. The first rotation member 30 is rotatable about the first connection shaft 31. The mounting base 10 is provided with the second mounting portion 12. The second mounting portion 12 is connected to the first segment 41 of the second rotation member 40 by the third connection shaft. The second rotation member 40 is rotatable about the third connection shaft. The mounting base 10 is provided with the first support portion 14 at the lower end of the mounting base 10. The mounting base 10 is connected to the lower end of the support rod 70 via a ball joint formed by the first support portion 14.

As illustrated in FIG. 5, the connection base 20 includes the first connection plate 21 and the second connection plate 22 connected to the first connection plate 21. The vehicle door connection hole 211 is formed at the first connection plate 21. The connection base 20 is fixed at the vehicle door 300 through the vehicle door connection hole 211. The second connection plate 22 is provided with the first connection portion 2211. The second end 52 of the first hinge arm 50 is connected to the second connection portion 2231 by the sixth connection shaft 82. The first hinge arm 50 is rotatable about the sixth connection shaft 82. The connection base 20 is provided with the second connection portion 2231. The fourth end 62 of the second hinge arm 60 is connected to the second connection portion 2231 by the fifth connection shaft 81. The second hinge arm 60 is rotatable about the fifth connection shaft 81. The second connection plate 22 is provided with the second support portion 23 at the lower end of the second connection plate 22. The second connection plate 22 is connected to the upper end of the support rod 70 via a ball joint formed by the second support portion 23.

As illustrated in FIG. 5, the first end 51 of the first hinge arm 50 is rotatably connected to the first rotation member 30 by the second connection shaft. The first hinge arm 50 is rotatable about the second connection shaft. The third end 61 of the second hinge arm 60 is rotatably connected to the second rotation member 40 by the fourth connection shaft 611. The second hinge arm 60 is rotatable about a center axis of the fourth connection shaft 611.

For the vehicle 1000 according to the embodiments of the present disclosure, when the vehicle door 300 is closed, the hinge assembly 100 is hidden between a fender of the vehicle body 200 and a space of the vehicle door 300, which achieves a neat appearance. When the vehicle door 300 needs to be opened, the support rod 70 pushes, through the connection base 20, the connection base 20 fixed at the vehicle door 300, which in turn drives the first rotation member 30, the second rotation member 40, the first hinge arm 50, and the second hinge arm 60 to rotate. In an exemplary embodiment of the present disclosure, in a process of pushing the vehicle door 300 by the support rod 70, the first rotation member 30 rotates outwards horizontally about the first axis L1 extending vertically, and the second rotation member 40 is pivoted upwards about the third axis L3 extending in the front-rear direction. The first hinge arm 50 is linked with the first rotation member 30. The second hinge arm 60 is linked with the second rotation member 40. In this way, the complex four-link mechanism is formed with the connection base 20 and the mounting base 10 to push the vehicle door 300 to be pivoted upwards and outwards synchronously.

With the vehicle 1000 according to the embodiments of the present disclosure, the hinge assembly 100 occupies a small volume, which is applicable to a wide range of small vehicles, and makes the door opening process more labor-saving. In addition, at initial opening of the vehicle door 300, an initial movement trajectory of the vehicle door 300 is more inclined to a pure Y-axis (left-right direction) rotation. In this way, the hinge assembly 100 can have a higher degree of versatility.

In the description of the present disclosure, it should be understood that the orientation or the position indicated by terms such as “center”, “longitudinal”, “transverse”, “length”, “width”, “thickness”, “over”, “below”, “front”, “rear”, “left”, “right”, “vertical”, “horizontal”, “top”, “bottom”, “inner”, “outer”, “clockwise”, “anti-clockwise”, “axial”, “radial”, and “circumferential” should be construed to refer to the orientation or the position as shown in the drawings, and is only for the convenience of describing the present disclosure and simplifying the description, rather than indicating or implying that the pointed device or element must have a specific orientation, or be constructed and operated in a specific orientation, and therefore cannot be understood as a limitation of the present disclosure.

In addition, the terms “first” and “second” are only used for descriptive purposes, and cannot be understood as indicating or implying relative importance or implicitly indicating the number of indicated technical features. Therefore, the features associated with “first” and “second” may explicitly or implicitly include at least one of the features. In the description of the present disclosure, “plurality” means at least two, unless otherwise specifically defined.

In the present disclosure, unless otherwise clearly specified and limited, terms such as “install”, “connect”, “connect to”, “fix”, and the like should be understood in a broad sense. For example, it may be a fixed connection or a detachable connection or connection as one piece; mechanical connection or electrical connection or communication; direct connection or indirect connection through an intermediate; internal communication of two components or the interaction relationship between two components. For those of ordinary skill in the art, the specific meaning of the above-mentioned terms in the present disclosure can be understood according to specific circumstances.

Reference throughout this specification to “an embodiment”, “some embodiments”, “an example”, “a specific example”, or “some examples” means that a particular feature, structure, material, or characteristic described in connection with the embodiment or example is included in at least one embodiment or example of the present disclosure. The appearances of the above phrases in various places throughout this specification are not necessarily referring to the same embodiment or example. Further, the particular features, structures, materials, or characteristics may be combined in any suitable manner in one or more embodiments or examples. In addition, different embodiments or examples and features of different embodiments or examples described in the specification may be combined by those skilled in the art without mutual contradiction.

Although embodiments of the present disclosure have been illustrated and described, it is conceivable for those of ordinary skill in the art that various changes, modifications, replacements, and variations can be made to these embodiments without departing from the principles and spirit of the present disclosure. The scope of the present disclosure shall be defined by the claims as appended and their equivalents.

What is claimed is:

1. A hinge assembly of a scissor door, the hinge assembly comprising:
a mounting base provided with a first mounting portion and a second mounting portion spaced apart from each other;
a connection base provided with a first connection portion and a second connection portion spaced apart from each other;
a first rotation member rotatably connected to the first mounting portion and provided with a first hinge portion;
a second rotation member rotatably connected to the second mounting portion and provided with a second hinge portion, the second hinge portion being rotatably connected to the second connection portion; and
a first hinge arm having a first end and a second end, the first end being rotatably connected to the first hinge portion, and the second end being rotatably connected to the first connection portion.

2. The hinge assembly according to claim 1, wherein:
the first rotation member is rotatable relative to the first mounting portion about a first axis; and
the first hinge arm is rotatable relative to the first rotation member about a second axis, the first axis intersecting with the second axis at a first intersection.

3. The hinge assembly according to claim 2, further comprising:
a second hinge arm having a third end and a fourth end, the third end being rotatably connected to the second hinge portion, and the fourth end being rotatably connected to the second connection portion.

4. The hinge assembly of the scissor door according to claim 3, wherein:
the second rotation member is rotatable about a third axis relative to the second mounting portion; and
the second hinge arm is rotatable about a fourth axis relative to the second rotation member, the first axis, the third axis, and the fourth axis intersecting at a second intersection, and the first intersection being non-coincident with the second intersection.

5. The hinge assembly according to claim 3, wherein:
the second hinge arm is rotatable about a fourth axis relative to the second rotation member; and
the second hinge arm is rotatable about a fifth axis relative to the second connection portion, the fourth axis intersecting with the fifth axis at a third intersection.

6. The hinge assembly according to claim 1, wherein:
the first hinge arm is rotatable about a second axis relative to the first rotation member;
the second hinge arm is rotatable about a fifth axis relative to the second connection portion; and
the first hinge arm is rotatable about a sixth axis relative to the first connection portion, the second axis, the fifth axis, and the sixth axis being parallel to each other.

7. The hinge assembly according to claim 1, wherein:
the mounting base is arranged vertically;
the second mounting portion is located below the first mounting portion and faces towards the connection base;
the first rotation member is rotatably disposed at the first mounting portion about a first axis, the first axis extending vertically; and
the second rotation member is rotatably disposed at the second mounting portion about a third axis, the third axis extending obliquely downwards from front to rear.

8. The hinge assembly according to claim 3, wherein:
the connection base comprises a first connection plate and a second connection plate;
the first connection plate extends in a left-right direction and is connected to a vehicle door;
the second connection plate is connected to a front side surface of the first connection plate and extends forwards; and
the first connection portion and the second connection portion are both disposed at the second connection plate.

9. The hinge assembly according to claim 8, wherein:
the second connection plate is arranged vertically and extends in a front-rear direction;
the second connection plate comprises a first plate segment, a bent segment, and a second plate segment that are sequentially connected from top to bottom, the first plate segment and the second plate segment being offset from each other in the left-right direction, and the first plate segment being connected to the second plate segment by the bent segment; and
the second end is connected to the first plate segment and located at a side of the first plate segment facing towards the bent segment in the left-right direction, and the fourth end is connected to the second plate segment and located at a side of the second plate segment facing towards the bent segment in the left-right direction.

10. The hinge assembly according to claim 1, wherein:
the first hinge arm is rotatably connected to the first rotation member about a second axis;
the first end and the second end of the first hinge arm are offset from each other in a direction parallel to the second axis; and
the first hinge arm further comprises a connection segment, wherein the connection segment has an end connected to the first end and another end extending obliquely towards the second end.

11. The hinge assembly according to claim 1, wherein the second rotation member is rotatable between a first position and a second position relative to the second mounting portion about a third axis, the third axis extending in a front-rear direction,
wherein when the second rotation member is at the first position, the second hinge portion is located below the third axis; and
wherein when the second rotation member is at the second position, the second hinge portion is located above the third axis.

12. The hinge assembly of the scissor door according to claim 11, wherein the second rotation member comprises a first segment and a second segment that are sequentially connected, wherein:
each of the first segment and the second segment extends along a straight line;
the first segment is obliquely arranged relative to the second segment, an obtuse angle being formed between the first segment and the second segment;
the first segment is connected to the second mounting portion;
the second hinge portion is formed at the second segment; and
the second mounting portion is located at a side of the second rotation member corresponding to an interior angle of the second rotation member.

13. The hinge assembly according to claim 1, further comprising:
a support rod having two ends respectively hinged to the mounting base and the connection base for driving the connection base to move relative to the mounting base.

14. A vehicle, comprising:
a vehicle body;
a vehicle door; and
the hinge assembly according to claim 1,
wherein the mounting base is fixed at the vehicle body; and
wherein the connection base is fixed at the vehicle door.

15. The vehicle according to claim 14, wherein:
the first rotation member is rotatable relative to the first mounting portion about a first axis; and
the first hinge arm is rotatable relative to the first rotation member about a second axis, the first axis intersecting with the second axis at a first intersection.

16. The vehicle according to claim 15, further comprising:
a second hinge arm having a third end and a fourth end, the third end being rotatably connected to the second hinge portion, and the fourth end being rotatably connected to the second connection portion.

17. The vehicle of the scissor door according to claim 16, wherein:
the second rotation member is rotatable about a third axis relative to the second mounting portion; and
the second hinge arm is rotatable about a fourth axis relative to the second rotation member, the first axis, the third axis, and the fourth axis intersecting at a second intersection, and the first intersection being non-coincident with the second intersection.

18. The vehicle according to claim 16, wherein:
the second hinge arm is rotatable about a fourth axis relative to the second rotation member; and
the second hinge arm is rotatable about a fifth axis relative to the second connection portion, the fourth axis intersecting with the fifth axis at a third intersection.

19. The vehicle according to claim 14, wherein:
the first hinge arm is rotatable about a second axis relative to the first rotation member;
the second hinge arm is rotatable about a fifth axis relative to the second connection portion; and
the first hinge arm is rotatable about a sixth axis relative to the first connection portion, the second axis, the fifth axis, and the sixth axis being parallel to each other.

20. The vehicle according to claim 14, wherein:
the mounting base is arranged vertically;
the second mounting portion is located below the first mounting portion and faces towards the connection base;
the first rotation member is rotatably disposed at the first mounting portion about a first axis, the first axis extending vertically; and
the second rotation member is rotatably disposed at the second mounting portion about a third axis, the third axis extending obliquely downwards from front to rear.
